(19) United States
(12) Patent Application Publication
(10) Pub. No.: US 2012/0242055 A1
(43) Pub. Date: Sep. 27, 2012

(54) BEARING, VEHICLE, AND METHOD FOR ASSEMBLING A VEHICLE

(75) Inventors: Richard STARCK, Falkenstein (DE); Dietmar ALBERT, Undenheim (DE)

(73) Assignee: GM GLOBAL TECHNOLOGY OPERATIONS LLC, Detroit, MI (US)

(21) Appl. No.: 13/428,025

(22) Filed: Mar. 23, 2012

(30) Foreign Application Priority Data
Mar. 25, 2011 (DE) 10 2011 015 011.0

(51) Int. Cl. B60G 11/22; F16C 19/22; F16F 7/00

(52) U.S. Cl. 280/124.145; 267/141; 384/125

(57) ABSTRACT

A bearing is provided for a vehicle having a receptacle element, which has an oval external contour for a connection to a vehicle body section of the vehicle and a passage for the accommodation of a piston rod of a spring strut of the wheel mount of the vehicle.

### CROSS-REFERENCE TO RELATED APPLICATION

This application claims priority to German Patent Application No. 10 2011 015 011.0 filed Mar. 25, 2011, which is incorporated herein by reference in its entirety.

### TECHNICAL FIELD

The technical field relates to a bearing, to a vehicle, and to a method for assembling a vehicle.

### BACKGROUND

FIG. 1A and FIG. 1B show a wheel suspension 100, 150 for a vehicle according to various solutions internally known to the applicant. The different wheel suspensions 100, 150 are linked to the same central girder 180 for better comparison, which does not correspond to reality, of course. The first wheel suspension 100 shown in FIG. 1A comprises a spring strut 102 having a shock absorber 104 and a spring 106. The spring strut 102 has a piston rod 108, which forms a part of the shock absorber 104, on its upper end. An upper spring plate 110 of the spring strut 102 and the piston rod 108 are supported by means of a bearing (not shown) on a vehicle body section (also not shown) of the vehicle. At its lower end, the spring strut 102 is connected to a wheel mount 112. The wheel mount 112 is linked by means of one or more swing arms 114 to the girder 180. The wheel mount 112 is connected to the swing arm 114 by means of a ball-and-socket joint 116. The bearing (not shown) and the ball-and-socket joint 116 allow pivoting of a wheel (not shown), which is fastened on the wheel mount 112, around a pivot axis 118, which intersects the bearing (not shown) and the ball-and-socket joint 116. For this purpose, the bearing has a roller bearing.

The wheel suspension 100 described in FIG. 1A is also referred to as a McPherson wheel suspension. This type of wheel suspension is easily producible. FIG. 1B shows a second wheel suspension 150, which is refined in relation to the first wheel suspension 100 and is particularly suitable for sport vehicles. Only the differences in relation to the wheel suspension 100 are discussed hereafter.

The wheel suspension 150 has a wheel mount 112, which is linked to the spring strut 102 by means of two ball-and-socket joints 152, for example. In order to steer the vehicle, the wheel mount 112 is pivoted together with the corresponding wheel around a pivot axis 154, which extends through the ball-and-socket joints 152. In particular, the pivot axis 154 does not extend through the bearing (not shown) of the wheel suspension 150, by means of which the spring strut 102 is supported on the vehicle body section (not shown). This has the result that the wheel is moved differently during steering of the vehicle, depending on whether the wheel suspension 100 or 150 is used. It has been shown that it is necessary in the case of the wheel suspension 150 to either offset the upper spring strut end together with the bearing (not shown) toward the vehicle center, or to have to accept a track width enlargement of the vehicle in relation to a vehicle having the wheel suspension 100. However, the enlargement of the track width is in turn accompanied by an adaptation of the vehicle body, in particular of the fender, which is costly.

Nonetheless, the desire exists to use both wheel suspensions 100, 150 in the same vehicle type, i.e., in the same vehicle body. The wheel suspension 100 or the wheel suspension 150 is to be installed depending on whether or not a sportier variant is desired. A wheel suspension is also known from the publication EP 0 092 066 A1.

At least one object is to provide a solution for the problems described above. In addition, other objects, desirable features, and characteristics will become apparent from the subsequent summary and detailed description, and the appended claims, taken in conjunction with the accompanying drawings and this background.

### SUMMARY

A bearing is provided for a vehicle having a receptacle element, which has an oval external contour for a connection to a vehicle body section of the vehicle and a passage for the accommodation of a piston rod of a spring strut of a wheel suspension of the vehicle. Furthermore, a vehicle having a bearing, in particular the bearing, having a vehicle body section that is connected to the bearing, having a wheel mount, and having a spring strut, which is fastened on the bearing on one side and on the wheel mount on the other side, the bearing allowing the fastening of the bearing-side end of the spring strut on two different positions in the transverse direction of the vehicle.

Furthermore, a method for assembling a vehicle, one end of a spring strut assembled with the bearing on a vehicle body section at a first or second position in the transverse direction of the vehicle, the first position being selected if a pivot axis of a wheel for steering the vehicle extends through the bearing, and the second position selected if the pivot axis does not extend through the bearing. This method allows simple fastening of the bearing-side end of the spring strut on two different positions in the transverse direction of the vehicle. This is made possible in particular by the oval external contour of the receptacle element of the bearing, which predefines two defined, different positions in the transverse direction of the vehicle in cooperation with the vehicle body section.

Therefore, wheel suspensions, in particular the two wheel suspensions mentioned at the beginning, which need fastening of the bearing-side end of a respective spring strut on two different positions in the transverse direction of the vehicle, can be installed in identical vehicle bodies. An enlargement of the track width of the vehicle is advantageously avoided. In the present case, “oval” means non-circular, in particular elliptical (the special case of the circular ellipse is excluded here).

According to embodiment of the bearing, the oval external contour is implemented as elliptical and/or the passage is arranged on an axis of symmetry of the ellipse, in particular approximately in one of the focal points of the ellipse. In the present case, “approximately” means a deviation from the corresponding focal point by at most a few millimeters.

According to a further embodiment of the bearing, the receptacle element has a rubber part, which is preferably reinforced with a metal inlay. The receptacle element therefore provides a certain degree of elasticity with high carrying capacity.

According to a further embodiment of the bearing, the receptacle element has a bearing seat opposite to the external contour, a roller bearing arranged between the bearing seat and a spring seat of the bearing, which is configured for a contact of a spring of the wheel suspension. This design relates to a McPherson wheel suspension.

According to a further embodiment of the vehicle, the oval external contour of the bearing engages in a formfitting manner in the vehicle body section in the transverse and longitudinal directions of the vehicle. The two different defined positions in the transverse direction of the vehicle thus result in a simple way. Assembly steps which go beyond the insertion of the oval external contour “the other way around” into the vehicle body section, in order to provide the fastening at the two different positions, are dispensed with.

According to a further embodiment of the vehicle, the oval external contour is supported in a formfitting manner on the vehicle body section in the vertical direction of the vehicle. According to a further embodiment of the vehicle, a wheel is held on the wheel mount so it is pivotable around a pivot axis, which does not extend through the bearing, to pivot of the vehicle. This design relates to a wheel suspension as explained at the beginning in connection with FIG. 1B.

### BRIEF DESCRIPTION OF THE DRAWINGS

The present invention will hereinafter be described in conjunction with the following drawing figures, wherein like numerals denote like elements, and:

FIG. 1A and FIG. 1B each show a perspective view of a wheel mount according to a solution internally known to the applicant;

FIG. 2A shows a top view of a bearing having a receptacle element according to an exemplary embodiment, the receptacle element located in a first position;

FIG. 2B, shows the view from FIG. 2A, the receptacle element being located in a second position;

FIG. 3A shows a sectional view from FIG. 2A, further details being shown;

FIG. 3B shows a section from FIG. 2B, further details being shown;

FIG. 4A shows a perspective view of a detail of a vehicle according to an exemplary embodiment, the receptacle element arranged in the position shown in FIG. 2A; and

FIG. 4B shows the view from FIG. 4A, the receptacle element being arranged in the position shown in FIG. 2B.

### DETAILED DESCRIPTION

The following detailed description is merely exemplary in nature and is not intended to limit application and uses. Furthermore, there is no intention to be bound by any theory presented in the preceding background or summary or the following detailed description.

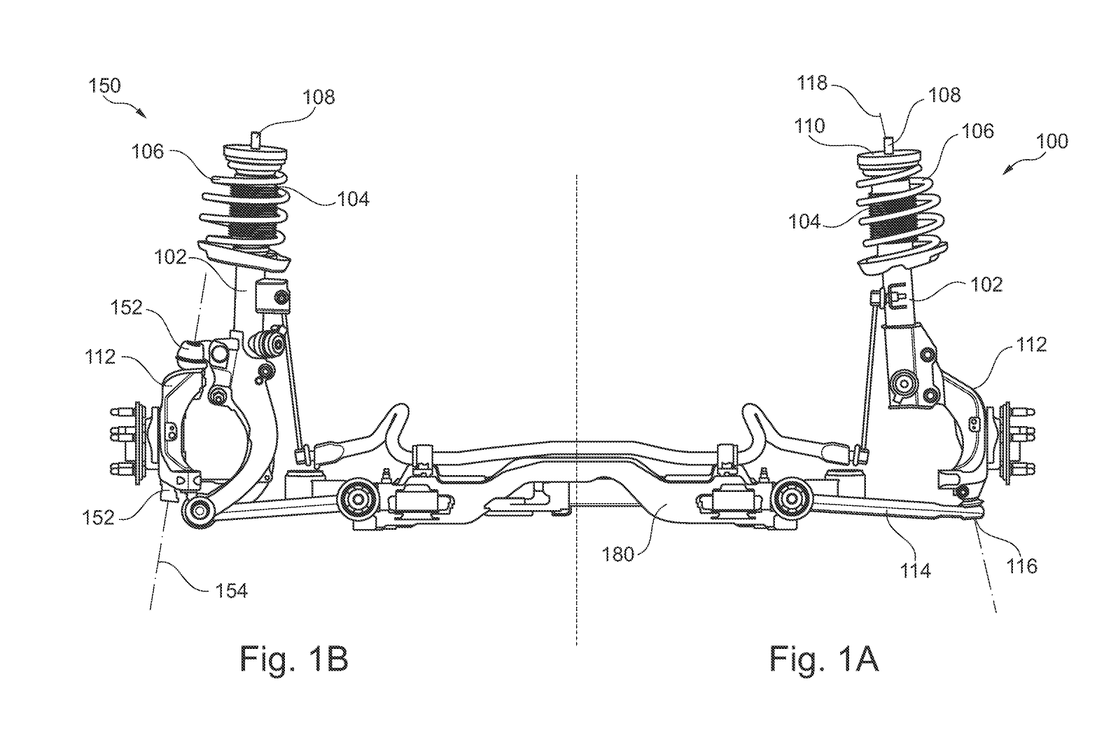

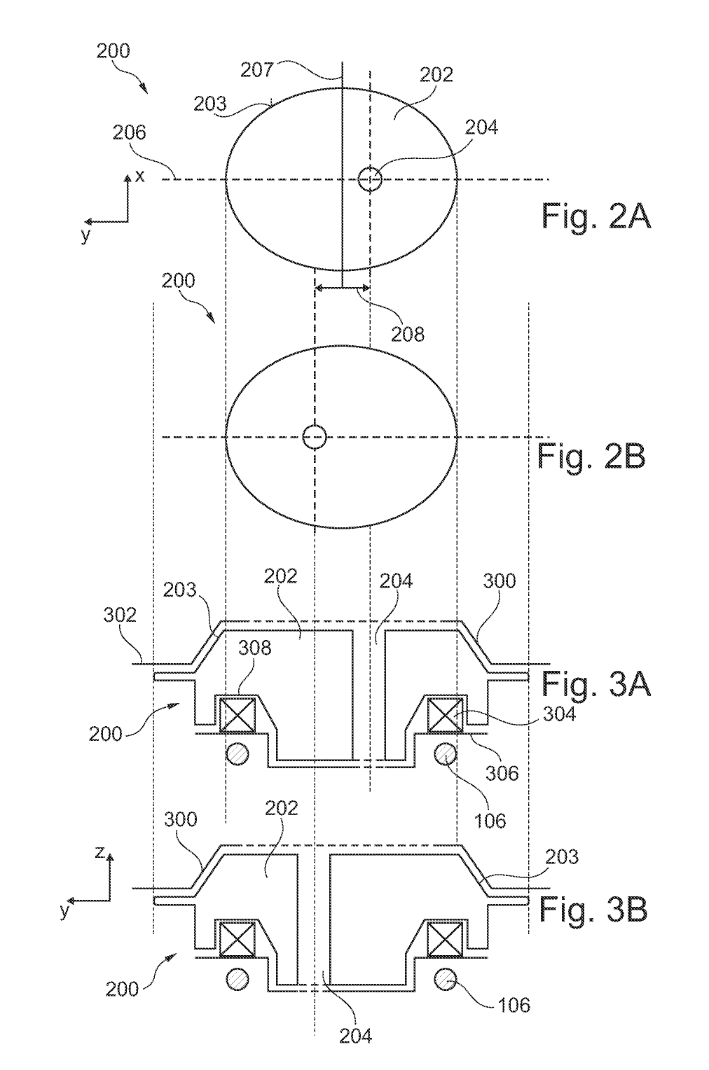

FIG. 2A shows a schematic top view of a bearing 200 having a receptacle element 202 for use with the wheel suspension 100 or the wheel suspension 150, as described in connection with FIG. 1A and FIG. 1B. Considered in the top view, i.e., along the spring strut 102; see FIG. 1A and FIG. 1B, the receptacle element 202 has an elliptical external contour 203. The receptacle element 202 is also provided with a passage 204. The passage 204 is provided on a first axis of symmetry 206 of the corresponding ellipse and offset to a second axis of symmetry 207, which perpendicularly intersects the first axis of symmetry 206. The passage 204 is preferably arranged in one of the focal points of the ellipse area. The receptacle element 202 preferably has a rubber part, which is preferably reinforced by means of a metal inlay (not shown).

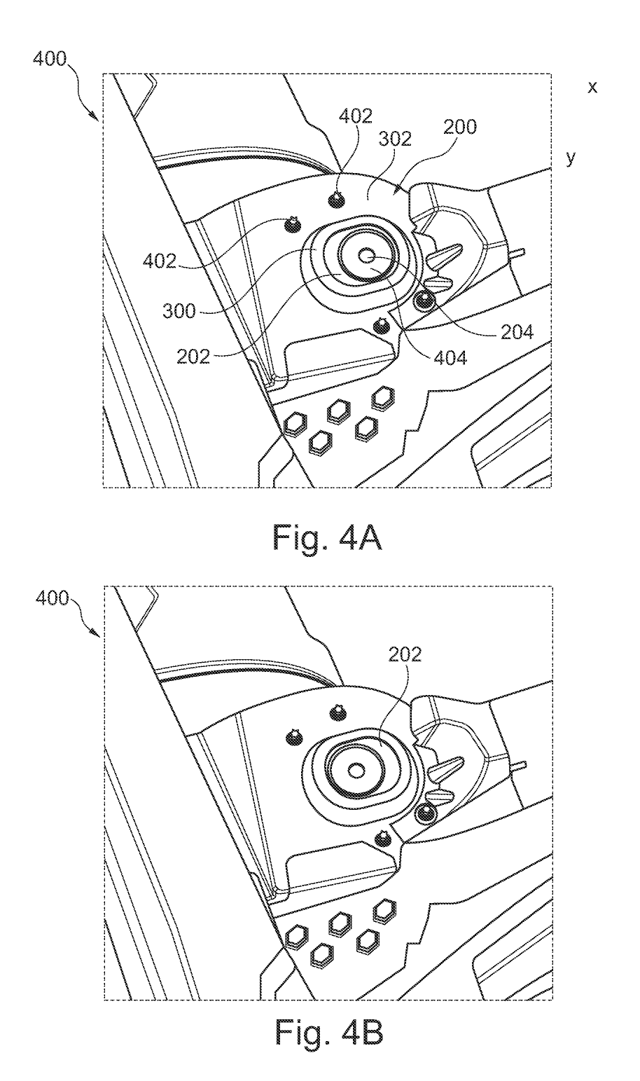

In the installed state of the bearing 200, the elliptical external contour engages in a pot-like area 300 of a vehicle body section 302 of the vehicle. This may be seen in the section from FIG. 2A shown in FIG. 3A. The pot-like area 300 has a corresponding elliptical shape, so that the receptacle element 202 can be inserted into the pot-like area 300 either in the first position, which is shown in FIG. 2A and FIG. 3A, or can be inserted into the pot-like area 300 in the second position, which is shown in FIG. 2B and FIG. 3B, of the receptacle element 202. In the inserted state, the receptacle element 202, in particular its external contour 203, forms a form-fit with the pot-like area 300 in the longitudinal and transverse directions X, Y of the vehicle 400, see also FIG. 4A. In the assembled state, the piston rod 108, see FIG. 1A and FIG. 1B is accommodated in the passage 204 and is held therein.

Furthermore, the bearing 200 can have a ball roller bearing 304 and a spring seat 306. The roller bearing 304 is accommodated between a bearing seat 308 of the receptacle element 202 and the spring seat 306. The spring seat 306 is therefore mounted so it is rotatable in relation to the receptacle element 202; in order to avoid tension of the spring 106 pressing against the spring seat 306, see FIG. 1A and FIG. 1B. The design having the roller bearing 304 suggests itself in particular in the case of the McPherson wheel suspension according to FIG. 1A. In the case of the wheel suspension 150 according to FIG. 1B, the roller bearing 304 is preferably omitted.

The bearing 200 therefore allows the bearing-side spring strut end, in particular the piston rod 108, to be fastened easily on two different positions, as needed, without having to change the vehicle body section 302 or the pot-like area 300. The distance between the two different positions in the transverse direction Y of the vehicle 400 is identified in FIG. 2A by the reference sign 208. The distance can be approximately 12 mm, for example.

FIG. 4A shows a detail from the vehicle 400, such as a motor vehicle, having the bearing 200. In consideration together with FIG. 3A, it may be recognized that the pot-like area 300, in cooperation with the receptacle element 202 or the external contour 203, also ensures a form-fit in the vertical direction Z of the vehicle 400. The receptacle element 202 can be solidly screwed onto the vehicle body section 302 by means of screws 402, so that fastening of the receptacle element 202 is ensured in all three spatial directions X, Y, and Z. An insert 404, for example, made of metal, which in turn forms the passage 204, can be inserted into the receptacle element 202.

The further components of the wheel suspension are not visible in FIG. 4A, because they are arranged below the area shown and are therefore concealed. FIG. 4A shows the receptacle element 202 in its first position shown in FIGS. 2A and 3A, while FIG. 4B shows the receptacle element 202 in its second position shown in FIG. 2B and FIG. 3B.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A bearing for a vehicle having a body section and a wheel mount, comprising:
a receptacle element;
an oval external contour of the receptacle element configured for connection to a vehicle body section of the vehicle; and
a passage configured to accommodate a piston rod of a spring strut of the wheel mount of the vehicle.

2. The bearing according to claim 1, wherein the oval external contour is ellipse.

3. The bearing according to claim 2, wherein the passage is arranged on an axis of symmetry of the ellipse.

4. The bearing according to claim 2, wherein the passage is arranged on approximately in a focal point of the ellipse.

5. The bearing according to claim 1, wherein the receptacle element comprises a rubber part that is reinforced with a metal inlay.

6. The bearing according to claim 1, wherein the receptacle element comprises:
a bearing seat opposite to the oval external contour; and
a roller bearing that is arranged between the bearing seat and a spring seat of the bearing, which is configured for a contact of a spring of a wheel suspension.

7. A vehicle comprising:
a bearing, comprising:
a receptacle element;
an oval external contour of the receptacle element configured for connection to a vehicle body section of the vehicle; and
a passage configured to accommodate a piston rod of a spring strut of a wheel mount of the vehicle;
wherein the vehicle body section is connected to the bearing and comprises the wheel mount and the spring strut fastened on the bearing on one side and on the wheel mount on the other side, and
wherein the bearing is configured to allow a fastening of a bearing-side end of the spring strut on two different positions in a transverse direction of the vehicle.

8. The vehicle according to claim 7, wherein the oval external contour of the bearing is configured to engage in a formfitting manner in the vehicle body section in the transverse and longitudinal directions of the vehicle.

9. The vehicle according to claim 7, wherein the oval external contour is supported in a formfitting manner on the vehicle body section in a vertical direction of the vehicle.

10. The vehicle according to claim 7, further comprising a wheel held on the wheel mount to pivot around a pivot axis that does not extend through the bearing that is configured for steering the vehicle.

11. The vehicle according to claim 7, wherein the oval external contour is an ellipse.

12. The vehicle according to claim 11, wherein the passage is arranged on an axis of symmetry of the ellipse.

13. The vehicle according to claim 11, wherein the passage is arranged on approximately in a focal points of the ellipse.

14. The vehicle according to claim 7, wherein the receptacle element comprises a rubber part that is reinforced with a metal inlay.

15. The vehicle according to claim 7, wherein the receptacle element comprises:
a bearing seat opposite to the oval external contour; and
a roller bearing arranged between the bearing seat and a spring seat of the bearing, which is configured for a contact of a spring of a wheel suspension.
